(19) United States
(12) Patent Application Publication
(10) Pub. No.: US 2006/0258297 A1
(43) Pub. Date: Nov. 16, 2006

(54) Method for operating a radio communication system, receiver station and sending station for a radio communication system

(76) Inventor: Wolfgang Zirwas, Grobenzell (DE)

Correspondence Address: STAAS & HALSEY LLP, SUITE 700, 1201 NEW YORK AVENUE, N.W., WASHINGTON, DC, 20005, US

(21) Appl. No.: 10/568,223

(22) PCT Filed: Jul. 13, 2004
(86) PCT No.: PCT/EP04/51469

§ 371 Date: Feb. 14, 2006

(30) Foreign Application Priority Data
Aug. 14, 2003 (DE) 10337445.0

(51) Int. Cl. H04B 7/00; H04B 1/00

(52) U.S. Cl. 455/69

(57) ABSTRACT

A receiving station of a radio communication system receives a signal from a sending station by a first transmitting channel. A channel parameter of the first transmitting channel is determined by the receiving station. A parameter of a direst data symbol which is to be transmitted fro the receiving station to the sending station by means of a second transmitting channel is adjusted according to the channel parameter for the communication of the channel parameter of the first transmitting channel to the sending station.

### CROSS REFERENCE TO RELATED APPLICATIONS

This application is based on and hereby claims priority to German Application No. 10337445.0 filed on 14 August 2003, the contents of which are hereby incorporated by reference.

### BACKGROUND OF THE INVENTION

The invention relates to a method for operating a radio communication system, and also a receiver station and sending station for such a radio communication system.

In radio communication systems, signals are transmitted in the form of electromagnetic waves through the air. With regard to transmission through the air, distortion of the signals to be transmitted occurs as a result of wide variety of different influences. As a result of these distortions, the signals received at a receiver station differ from the signals sent out by the corresponding sending station.

Numerous research projects are being carried out at the present time in the field of the so-called MIMO (Multiple Input Multiple Output) antennas for radio communication systems. In this situation, both the sender and also the receiver each have a plurality of antennas. The MIMO technology can be employed for example for space multiplexing or in order to achieve diversity gains. MIMO can substantially increase the performance of a radio system, for example the spectral efficiency. However, the performance depends on the accuracy of the information relating the transmission channels between sender and receiver in both transmission directions. In order to achieve the best results, information is required about the transmission channel both in the one direction and also in the other direction. Since MIMO systems involve the use of a large number of sending and receiving antennas and a separate transmission channel with its own individual transmission properties is formed between each pair of antennas, a knowledge of the transmission properties of a very large number of channels is required in such a system. One of the reasons the number of channels is so large is because the transmission function from each sending antenna to each receiving antenna—in other words also the interference between the antennas—must be known for powerful algorithms.

With regard to radio systems which use the same frequency band for both transmission directions, from a knowledge of the properties of the channel for the one transmission direction it is possible to draw conclusions about the properties of the channel for the other transmission direction. If, on the other hand, different frequencies are used for each transmission direction, the channel properties may differ significantly, with the result that this procedure is not possible.

In order to provide the sender with information about the transmission channel between sender and receiver, it would now be possible to generate the corresponding information at the receiver on the basis of signals received thereby and to subsequently convey it to the sender. However, this would require that additional transmission capacity be made available in order to convey this information.

With regard to radio channels which change rapidly, this information must moreover be conveyed very frequently.

### SUMMARY OF THE INVENTION

An object of the invention is to convey corresponding information about properties of a transmission channel with the minimum possible demand on resources from a receiver station to a sending station.

The method for operating a radio communication system makes provision whereby a receiver station receives a signal by way of a first transmitting channel from a sending station. A channel parameter of the first transmitting channel is determined by the receiver station. A parameter of a first data symbol which is to be transmitted from the receiver station to the sending station by way of a second transmitting channel is adjusted as a function of the channel parameter for the communication of the channel parameter of the first transmitting channel to the sending station.

The channel parameter of the first transmitting channel corresponds to an item of information about the first transmitting channel. In this situation, this can for example be a phase parameter, in other words information about a phase shift occurring as a result of the transmission by way of the first transmitting channel, or it can also be an amplitude parameter, in other words an amplitude attenuation occurring as a result of the transmission by way of the first transmitting channel. The channel parameter of the first transmitting channel can be advantageously ascertained by the receiver station carrying out a channel estimate for the first transmitting channel. Methods for channel estimation are common knowledge to the person skilled in the art. Channel estimates can be carried out for example by correlating received pilot symbols with versions of the pilot symbols stored in the receiver station.

As a result of the invention it is possible to convey the channel parameter of the first transmitting channel from the receiver station to the sending station without any additional demand on transmission capacity. This is achieved by the fact that as a result of the value of the channel parameter merely one parameter of a first data symbol which is to be transmitted in any case from the receiver station to the sending station is changed. On the side of the sending station which receives this first data symbol it is then possible to extract the information about the channel parameter of the first transmitting channel again from the received first data symbol.

The recovery of the value of the channel parameter from the received first data symbol by the sending station can be effected easily for example in the situation when the first data symbol is a symbol known to the sending station. The first data symbol can for example be a pilot symbol which is used simultaneously by the sending station for estimating the second transmitting channel between receiver station and sending station.

If the first data symbol of the sending station is not known, the value of the first channel parameter can be determined by the sending station as a result of the fact that, for example, not only a parameter of a first data symbol but also of a second data symbol, which is to be transmitted by way of the second transmitting channel from the receiver station to the sending station, is influenced by the receiver station through the same channel parameter. Advantageously, the parameter of the first data symbol to be transmitted from the receiver station to the sending station is changed by addition of the value of the channel parameter, whereas a parameter of the second data symbol to be transmitted from the receiver station to the sending station is changed by subtraction of the value of the channel parameter.

The second data symbol can be conveyed before or after the first data symbol from the receiver station to the sending station.

Since the channel parameter of the first transmitting channel influences the value of the parameter of the first data symbol, it is possible with the invention to convey the channel parameter in analog form to the sending station.

In particular, the invention can also be applied without requiring any far-reaching changes to the corresponding system standard in radio systems for which such a procedure has not previously been provided in the corresponding standard. This invention can be employed in known radio systems without any change to the definition of the air interface because it is simply necessary to adapt the sending station and the receiver station such that the influence on the parameter of the first data symbol by the channel parameter of the first transmitting channel and also the extraction of this information are possible at the sending station.

The invention can be employed in any desired radio communication systems. In particular, it is also suitable for use in mobile radio systems. It is particularly suitable for use in systems in which a large number of first transmitting channels are employed between sending station and receiver station, such as is the case with MIMO systems for example. With regard to such systems, it is particularly advantageous that as a result of the invention no additional transmission resources are required in order to make the channel parameter known to the sending station.

The invention is suitable for example for use in OFDM systems (Orthogonal Frequency Division Multiplex). It can also be employed in the third generation CDMA mobile radio systems (for example UMTS, CDMA 2000) currently under construction.

The parameter of the first data symbol to be transmitted from the receiver station to the sending station can optionally be changed by the addition or subtraction of the value of the channel parameter of the first transmitting channel.

If the data symbols to be transmitted from the receiver station, the parameter of the data symbols being changed as a function of the channel parameter of the first transmitting channel, are pilot symbols which are known from the outset to the sending station and which are used for an estimation of the second transmitting channel by the sending station, then the determination of the channel parameter by the sending station can be carried out particularly easily. By virtue of the fact that with regard to the first data symbol for example the parameter is then changed by addition of the value of the channel parameter of the first transmitting channel and the parameter of the second data symbol is changed by subtraction of the channel parameter, the channel parameter can be easily determined by the sending station.

Particularly when the first and the second data symbol are identical, it is possible by simple addition of the parameters of the received first and second data symbols ascertained by the sending station and subsequent division by two to determine the value of the channel parameter. The first and second data symbols do not need to be known to the sending station in this case.

If the first and second data symbols are identical pilot symbols, known to the sending station, it is possible to simultaneously carry out a channel estimate of the second transmitting channel using these two pilot symbols. To this end, it is simply necessary to subtract the parameters of the received first and second data symbols ascertained by the sending station from one another and subsequently to divide them by two.

After a channel estimate of the second transmitting channel has also been carried out using these two pilot symbols, which preferably takes place at the beginning of a transmission frame, it can be approximately assumed [by] the sending station for following data symbols, which then no longer necessarily need to be known to the sending station, that the second transmitting channel will only change slightly. The sending station can then, even in the case of an unknown first and second data symbol which is conveyed to it from the receiver station, perform a correct data detection for these using the channel parameters ascertained beforehand for the second transmitting channel, whereby it can be assumed that differences in the phase diagram between the ideal value of the phase of the symbol to be detected and the phase actually ascertained can be tracked back to the addition or subtraction of the channel parameter of the first transmitting channel by the receiver station.

The receiver station according to the invention and the sending station according to the invention have the requisite components in order to allow their use for implementation of the method according to the invention.

Although the terms “receiver station” and “sending station” are used for the two stations considered here, it goes without saying that both stations are capable of both sending and also receiving data.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of an embodiment of the radio communication system according to the invention, and

FIG. 2 is a graph showing the change in a parameter of data symbols made by the receiver station from FIG. 1.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

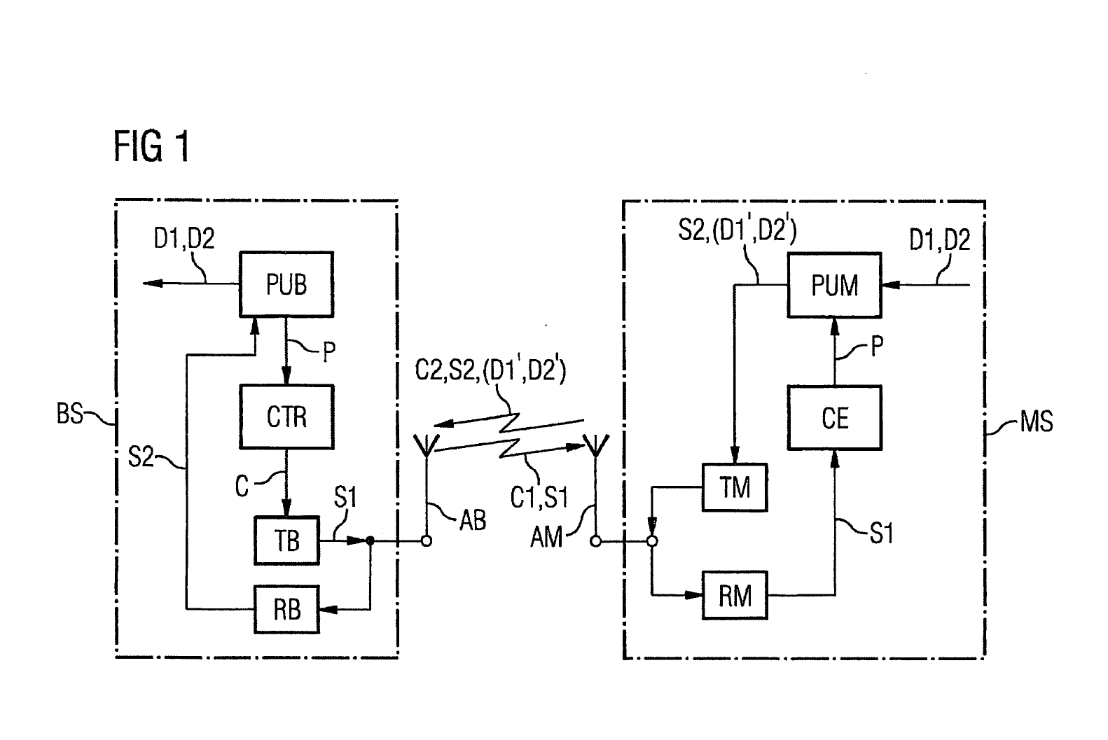

FIG. 1 shows a radio communication system according to the invention, taking a mobile radio system by way of example.

Mobile radio systems have network-side base stations which are stationary and each serve to support one of a large number of radio cells. User stations of the mobile radio system, which are as a rule mobile, can maintain a communications link by way of the base stations.

FIG. 1 shows a sending station BS in the form of a base station and a receiver station in the form of a user station MS of the mobile radio system. The sending station BS has at least one antenna AB which is used for sending and receiving signals to and from the receiver station MS respectively. The receiver station MS has at least one antenna AM which is used for receiving and sending signals from and to the sending station BS respectively. In a first frequency range the sending station BS conveys a first signal S1 by way of a first transmitting channel C1 to the receiver station MS. In a second frequency range the receiver station MS sends second signals S2 by way of a second transmitting channel C2 to the sending station BS. On account of the use of different frequency ranges for the downlink direction and uplink direction the system in question is a so-called FDD (Frequency Division Duplex) system. The transmitting channels C1, C2 may also differ from one another additionally or alternatively through further parameters, for example through different spreading codes or different time slots.

The sending station BS has a transmitting unit TB which generates the first signal S1, which is subsequently transmitted by way of the antenna AB and the first transmitting channel C1 to the antenna AM of the receiver station MS. The receiver station MS has a receiving unit RM from which the first signal S1 is fed to a channel estimation unit CE. The channel estimation unit CE makes an estimate of the first transmitting channel C1 on the basis of the first signal S1. This happens by virtue of the fact that the first signal S1 contains pilot symbols which are known to the receiver station MS. The channel estimation unit CE performs a correlation between the received pilot symbols and a version of these pilot symbols stored in the receiver station MS in order to ascertain the properties of the first transmitting channel C1. As the result of the channel estimation the channel estimation unit CE ascertains at least one channel parameter P of the first transmitting channel C1. With regard to the present embodiment the channel parameter P in question is a phase parameter, in other words information about a phase shift which the first signal S1 experiences as a result of the transmission by way of the first transmitting channel C1.

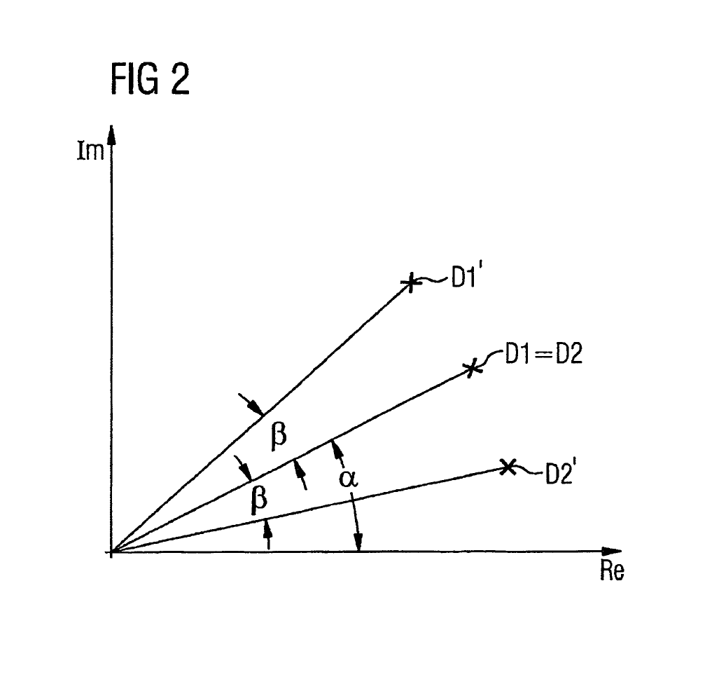

Furthermore, the receiver station MS contains a processing unit PUM, to which the channel parameter P is fed by the channel estimation unit CE. Moreover, a first data symbol D1 and a second data symbol D2 which are to be transmitted to the sending station BS independently of the channel estimate of the first transmitting channel C1 are fed to the processing unit PUM. The processing unit PUM of the receiver station MS now varies one parameter of the two data symbols D1, D2, namely their phase, depending on the channel parameter R This is described in more detail further below with reference to FIG. 2. The processing unit PUM delivers as its result a signal S2 with modified data symbols D1′, D2′ to a sending unit TM of the receiver station MS. The sending unit TM transmits the second signal S2 to the antenna AM of the sending station MS, from which the second signal S2 is conveyed by way of the second transmitting channel C2 to the antenna AB of the sending station BS.

From the antenna AB of the sending station BS, the second signal S2 passes by way of a receiving unit RB of the sending station BS to a processing unit PUB. The processing unit PUB separates the original data symbols D1, D2 from the channel parameter P by an operation which is the opposite of that of the processing unit PUM of the receiver station MS. The channel parameter P is subsequently fed to a control unit CTR which as a function thereof generates corresponding control signals C which are fed to the sending unit TB of the sending station BS and are used there for adjusting the sending unit TB or the antenna AB. In this manner the send properties of the sending station BS can be matched to the properties of the first transmitting channel C1 in order that the transmission in this direction may be improved.

FIG. 2 shows a phase diagram in which the data symbols D1, D2 that are to be sent out by the receiver station MS in FIG. 1 have been entered according to their real part Re and imaginary part Im. With regard to this embodiment it has been assumed that the two data symbols D1, D2 are identical, in other words exhibit the same phase and same amplitude. They have a phase angle a and an amplitude which are determined by their distance from the coordinate origin. With regard to this embodiment the channel parameter P should, as mentioned above, be a phase parameter. The value of the channel parameter P is an angle β. The processing unit PUM of the receiver station MS now modifies the angle a of the first data symbol D1 by increasing this by the angle β. This produces the resulting first data symbol D1′ with the phase angle α+β. The phase of the second data symbol D2, which likewise corresponds to the angle α, is modified by the fact that the angle β, in other words the value of the channel parameter P of the first transmitting channel C1, is subtracted from this. From this is produced the resulting second data symbol D2′. The resulting second data symbol D2′ consequently has a phase of α−β.

With regard to this embodiment, only the phase of the first and second data symbols D1, D2 is adjusted depending on the channel parameter P. With regard to other embodiments of the invention, as an alternative to or in addition to the phase it is also possible to change the amplitude of the data symbols D1, D2 as a function of an amplitude parameter of the first transmitting channel C1. This would have the consequence that the distance of the resulting data symbols D1′, D2′ from the coordinate origin of the phase diagram from FIG. 2 is greater or smaller than the distance of the original data symbols D1, D2. In the representation shown in FIG. 2, however, the distance of the original data symbols D1, D2 and of the resulting data symbols D1′, D2′ from the coordinate origin is identical in each case, since no amplitude parameters of the first transmitting channel C1 are taken into consideration here.

The transmission of information by way of an amplitude parameter of the first transmitting channel could be problematic in individual cases since high peaks or strong dips in the signal transmitted by way of the first transmitting channel can lead to the signal with which the first data symbol is transmitted becoming very small or attaining very large amplitude values. In order to avoid this, it can make sense not to transmit an amplitude parameter but simply to transmit a phase parameter of the first transmitting channel from the receiver station to the sending station in the described manner. In MIMO systems in particular, information about the phase shift is in any case of greater relevance than information about the amplitude shift.

The transmission of amplitude values as channel parameters of the first transmitting channel through modification of a parameter of the first data symbol D1 can advantageously take place in the following ways:
a) Amplitude values of the first transmitting channel, which have been ascertained on the basis of pilot symbols transmitted by way of the first transmitting channel, are reduced in each case by a previously defined factor thus, the situation is avoided whereby very large or very small amplitude values occur as a result of addition or subtraction of these amplitude values to/from the corresponding amplitude values of the first and second data symbol. As a result, however, the accuracy of the conveyed amplitude values diminishes to a certain extent.
b) It would be possible to limit the maximum or minimum number of resulting amplitude values of the amplitude of the first and the second data symbol after carrying out the addition or subtraction respectively of the amplitude values of the first transmitting channel.
c) The amplitude values to be transmitted can be re-coded into phase values. This means that the amplitude values of the first and second data symbols, which are to be transmitted by way of the second transmitting channel, are no longer changed at all by the amplitude values ascertained for the first transmitting channel. Instead, a conversion of the amplitude values into corresponding phase values takes place in accordance with a coding operation to be specified beforehand in the receiver station. This conversion is then canceled again in the context of a decoding operation in the sending station. In order to transmit both phase values and also amplitude values for the first transmitting channel by way of the second transmitting channel to the sending station in the case of such a system, four data symbols for example are then required, however: two data symbols with which the phase value is transmitted and two further data symbols with which the associated amplitude value is transmitted.

With regard to this embodiment, it is assumed that the second data symbol D2 is transmitted immediately after the first data symbol D1 from the receiver station MS to the sending station BS. For data symbols which are not transmitted immediately after one another it can be assumed that the two transmitting channels C1, C2 behave in a stationary manner. This assumption holds true as long as the two data symbols are transmitted within the coherence time of the transmitting channel used. This is the time during which the transmitting channel does not change significantly in the meantime. In the case of a moving sending station or receiver station the coherence time depends essentially on the speed of the mobile stations.

With regard to this embodiment, the first and second data symbols D1, D2 are likewise pilot symbols which are used by the sending station BS for estimating the second transmitting channel C2. The two data symbols D1, D2 are therefore known to the sending station BS. On account of the stationary nature of the second transmitting channel C2 during transmission of the two data symbols D1, D2, it is possible by simple subtraction of the phase of the second resulting data symbol D2′ (α−β) from the phase of the first resulting data symbol D1′ (α+β) and subsequent division by 2 to calculate the value β of the channel parameter P of the first transmitting channel C1 in the receiver station BS:
β=((α+β)−(α−β))/2.

On account of the stationary nature of the second transmitting channel C2 during the period of time in question the phase shift which occurs during the transmission of the resulting data symbols D1′, D2′ is the same for both data symbols. This influence of the second transmitting channel C2 is worked out again automatically by the subtraction described above and does not affect the result.

If the minus sign between the parenthesized expressions in the above formula is changed into a plus sign, the result obtained is the value of α, in other words the phase value for the first and second data symbol without added or subtracted phase values β of the first transmitting channel. α can be used for performing a channel estimate of the second transmitting channel using the first and second data symbols D1, D2 since, as mentioned above, these are pilot symbols known to the sending station. A phase value a deviating from the expected phase value of the pilot symbol is dependent on the phase shift of the second transmitting channel C2.

In particular, the invention can be used advantageously when the sending station BS and the receiver station MS each have a large number of antennas AB, AM which are operated as so-called smart antennas. A knowledge of the properties of the first transmitting channel C1 is advantageous in the case of such systems (particularly if these are MIMO systems) on the side of the sending station BS in order to ensure the best possible performance from the system.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-11. (canceled)

12. A method for operating a radio communication system, comprising:
receiving a signal in a receiver station by way of a first transmitting channel from a sending station;
determining, by the receiver station, a channel parameter of the first transmitting channel; and
adjusting a symbol parameter of at least a first data symbol to be transmitted from the receiver station to the sending station by way of a second transmitting channel, as a function of the channel parameter for communication of the channel parameter to the sending station.

13. A method according to claim 12, further comprising:
transmitting the data symbol from the receiver station to the sending station; and
ascertaining at the sending station the channel parameter of the first transmitting channel determined by the receiver station, based on the at least one data symbol received at the sending station.

14. A method according to claim 13, wherein the channel parameter of the first transmitting channel is at least one of a phase parameter and an amplitude parameter.

15. A method according to claim 14, wherein said adjusting includes changing the symbol parameter of the first data symbol to be transmitted from the receiver station to the sending station by at least one of addition and subtraction of a value of the channel parameter of the first transmitting channel.

16. A method according to claim 15, wherein said adjusting includes changing the symbol parameter of a second data symbol to be transmitted from the receiver station to the sending station by an opposite mathematical operation compared the changing of the first data symbol by the value of the channel parameter of the first transmitting channel.

17. A method according to claim 16, wherein the first and second data symbols transmitted from the receiver station are pilot symbols.

18. A method according to claim 16, wherein the first and second data symbols transmitted from the receiver station are user data.

19. A method according to claim 16, wherein a plurality of available transmitting channels exist for transmission from the sending station to the receiver station and said receiving, determining, adjusting, transmitting and ascertaining are repeated using each of the available transmitting channels as the first transmitting channel.

20. A method according to claim 19,
wherein the receiver station has a plurality of receiving antennas and/or the sending station has a plurality of sending antennas, and
wherein one of the first transmitting channels is in each case situated between one of the sending antennas and one of the receiving antennas.

21. A receiver station for a radio communication system having a sending station, comprising:
a receiving unit receiving a signal from the sending station by way of a first transmitting channel;
a determination unit determining a channel parameter of the first transmitting channel; and
an adjustment unit changing a symbol parameter of at least one data symbol, to be transmitted from said receiver station to the sending station by way of a second transmitting channel, as a function of the channel parameter of the first transmitting channel for communication of the channel parameter to the sending station.

22. A sending station for a radio communication system having at least one receiver station, comprising:
a transmission unit sending a signal by way of a first transmitting channel to the receiver station;
a receiver unit receiving from the receiver station at least one data symbol having a symbol parameter adjusted for communication of a channel parameter of the first transmitting channel as a function of the at least one channel parameter; and
an ascertainment unit ascertaining the channel parameter based on the at least one data symbol received from the receiver unit.
